(19) United States
(12) Patent Application Publication
(10) Pub. No.: US 2015/0321899 A1
(43) Pub. Date: Nov. 12, 2015

(54) EQUESTRIAN TACK WITH REPLACEABLE DECORATIVE COVERS

(71) Applicant: Sherri L. Ball, Troutman, NC (US)

(72) Inventor: Sherri L. Ball, Troutman, NC (US)

(21) Appl. No.: 14/274,983

(22) Filed: May 12, 2014

(51) Int. Cl. B68B 5/00; B44C 1/10

(52) U.S. Cl. CPC B68B 5/00; B44C 1/10

(57) ABSTRACT

A decorative cover for being removably applied to an outer surface of an equestrian tack component, and including a substrate having a size and shape corresponding to the surface of the tack to be covered and decorative elements applied to an outer-facing surface of the substrate. An inner-facing surface of the substrate is adapted for being removably carried by the tack.

### TECHNICAL FIELD AND BACKGROUND OF THE INVENTION

The present application relates generally to equestrian tack provided with features that permit quick and easy replacement of outer decorative elements. “Tack” refers to a piece of equipment or accessory placed on horses in the course of their use as domesticated animals. Saddles, stirrups, headstalls, bridles, halters, reins, bits, harnesses, martingales, and breastplates are all forms of horse tack. More specifically, the tack described in this application is equine headstalls, bridles and breast plates.

The headstall and the bridle are not precisely the same, but the terms can be used interchangeably, depending on what discipline of riding is involved. The term headstall is used primarily in western riding, and refers to the piece of equipment that goes on the horse's head and attaches to the cheek pieces, which hold the bit in his mouth. By itself, a headstall is not a functional piece of equipment, but is a piece of the bridle. It is the central piece of the bridle and is a necessary complement to the bridle. The headstall can be as simple as a plain piece of leather or nylon that goes behind the ears and has cheek pieces that attach to the bit on either end. Most western headstalls feature either a brow band or a split ear design. Some also have a throat latch. It is normal to have additional pieces added to the headstall to make a more complete and functional piece of tack.

The term “bridle” is the term used to describe the device that holds the bit in the horse's mouth. A bridle includes multiple components, including the brow band, throat latch, noseband, headstall, cheek pieces, bit and reins. The headstall and bridle serve the same basic function. The headstall will attach to the cheek pieces and the bit is attached at the end of the cheek pieces. The reins then are fastened to the bit. The pressure on the bit is used to steer the horse and direct him when to stop. While terminology can vary slightly, function does not.

By convention, this application uses the term “headstall” to refer to the headstall itself as well as related components that may also be part of the bridle.

An equine breastplate includes a yoke with a neck and wither strap, a breast strap at the bottom of the yoke which runs through the horse's front legs and attaches to the girth, and two straps at the top of the yoke which attach to the D-rings of a saddle. There are usually buckles for adjusting the size of the yoke as well as the length of the straps which attach to the saddle and girth. The breastplate helps to prevent the saddle from slipping. Breastplates are most commonly made of leather, and some have elastic inserts on the yoke to help prevent it from restricting the horse's shoulders. Those used in endurance riding are commonly made of lightweight nylon or another synthetic material. Terminology varies somewhat depending on the type of riding being carried out. As used in this application, the term breastplate is used generally to describe a device that extends between the horse's front legs and attaches to the saddle.

Tack such as headstalls and breastplates are often highly decorated. The decorations may include tooling, beadwork, fringe, tassels, metalwork, jewels, braided and woven materials, among other types of decoration. The decoration may add substantially to the cost of the tack without affecting its utility. Especially with regard to show horses, owners prefer not to show a horse more than once with the same tack decoration. Therefore, there is a need for a quick, easy and inexpensive way of using the same functional tack components with the ability to change the decorative appearance.

### SUMMARY OF THE INVENTION

It is therefore an object of the invention to provide tack that includes removable and replaceable decorative elements adapted for attachment to the functional tack elements.

It is another object of the invention to provide a headstall that includes removable and replaceable decorative elements adapted for attachment to the headstall straps.

It is another object of the invention to provide a breastplate that includes removable and replaceable decorative elements adapted for attachment to the yoke and breastplate straps.

These and other objects and advantages of the present invention are achieved in the preferred embodiment disclosed below by providing a decorative cover for being removably applied to an outer surface of an equestrian tack component, and including a substrate having a size and shape corresponding to the surface of the tack to be covered and decorative elements applied to an outer-facing surface of the substrate. An inner-facing surface of the substrate is adapted for being removably carried by the tack.

In accordance with another embodiment of the invention, attachment means are carried by the inner-facing surface for cooperating with complementary attachment means carried by the outer surface of the tack component.

In accordance with another embodiment of the invention, the attachment means are selected from the group consisting of magnets and ferrometallic elements, touch fasteners, cohesive tapes, double-sided tape and snap sets.

In accordance with another embodiment of the invention, the decorative cover has a size and shape corresponding to the surface desired to be covered of a headstall cheek strap.

In accordance with another embodiment of the invention, the decorative cover has a size and shape corresponding to the surface desired to be covered of a headstall brow band.

In accordance with another embodiment of the invention, the decorative cover has a size and shape corresponding to the surface desired to be covered of a neck and withers strap of a breastplate.

In accordance with another embodiment of the invention, the decorative cover has a size and shape corresponding to the surface desired to be covered of a breast strap of a breastplate.

In accordance with another embodiment of the invention, a decorative cover is provided for being removably applied to an outer surface of an equestrian tack component, which includes a substrate having a size and shape corresponding to the surface of the tack to be covered and decorative elements applied to an outer-facing surface of the substrate. An inner-facing surface is adapted for being removably carried by the tack. Attachment means are carried by the inner-facing surface for cooperating with complementary attachment means carried by the outer surface of the tack component that are selected from the group consisting of magnets and ferrometallic elements, touch fasteners, cohesive tapes, double-sided tape and snap sets.

In accordance with another embodiment of the invention a set of decorative covers is provided for being removably applied to an outer surface of an equestrian tack component, and include a plurality of substrates having sizes and shapes corresponding to the surfaces of respective first and second headstall cheek straps, a headstall brow band, and first and second neck and withers strap of a breastplate. Decorative elements are applied to an outer-facing surface of the substrates, and an inner-facing surface of each substrate adapted for being removably carried by the tack. Attachment means are carried by the inner-facing surface for cooperating with complementary attachment means carried by the outer surface of the tack component. The attachment means are selected from the group consisting of magnets and ferrometallic elements, touch fasteners, cohesive tapes, double-sided tape and snap sets.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a perspective view of the head, neck and withers of a horse wearing a headstall and breastplate according to an embodiment of the invention;

FIG. 2 is a plan view of a headstall according to one preferred embodiment of the invention; and

FIG. 3 is a plan view of a breastplate according to one preferred embodiment of the invention.

### DESCRIPTION OF THE PREFERRED EMBODIMENT AND BEST MODE

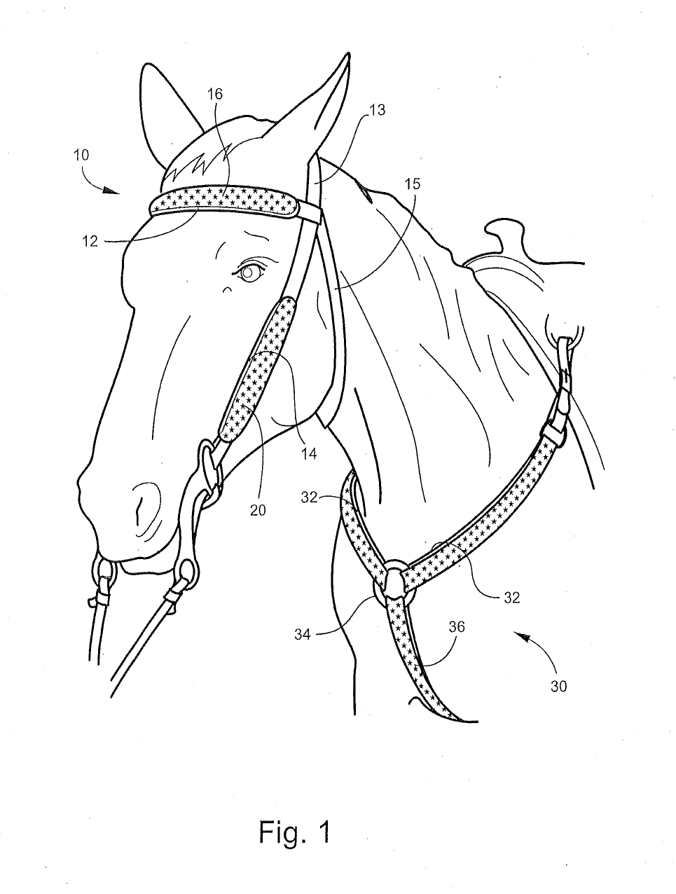

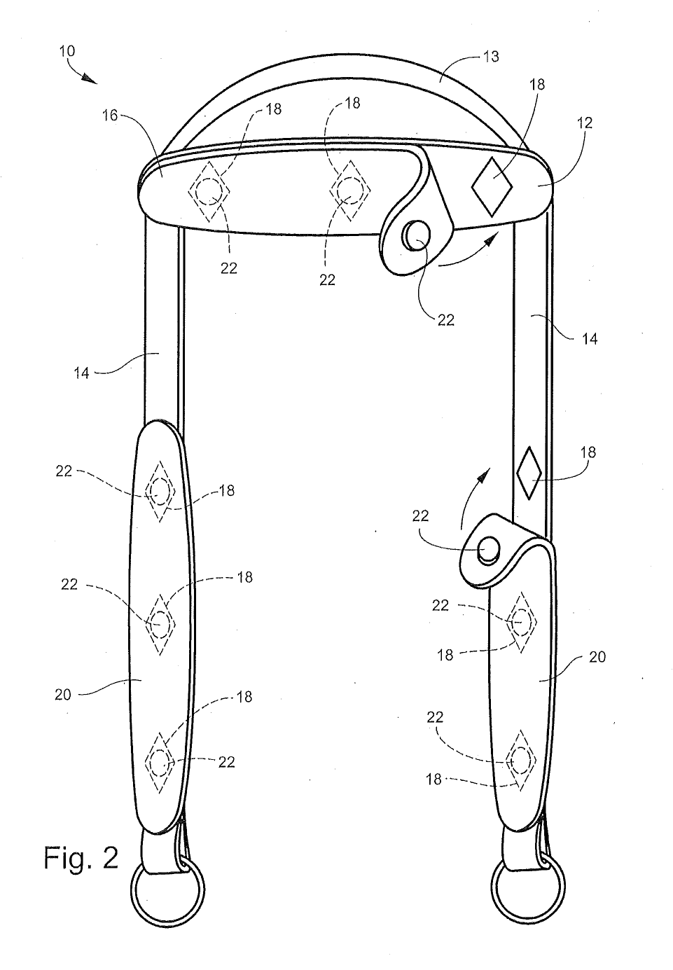

Referring now to FIGS. 1 and 2, a headstall 10 according to a preferred embodiment of the invention is shown. The headstall 10 includes brow band 12 that extends across the forehead of the horse between the eyes and ears, a headpiece 13, a pair of cheek straps 14 that extend along the cheeks of the horse and attach to the bit, and a throat latch 15 that extends from the headpiece 13 under the horse's throat. The brow band 12 is shown positioned beneath a substrate in the form of a decorative brow band cover strap 16 that is easily removable and replaceable when desired. Similarly, the cheek straps 14 are shown positioned beneath a substrate in the form of a cheek cover strap 20 that is also easily removable and replaceable when desired. The crosshatching on the brow band cover strap 16 and the cheek cover strap 20 of FIG. 1 is intended to represent any desired decoration, including those described above by way of illustration. The crosshatching is omitted from the brow band cover strap 16 and the cheek cover straps 20 in FIG. 2 for clarity.

As more specifically shown in FIG. 2, the brow band 12 and cheek straps 14 each include spaced-apart contact points 18. In accordance with one preferred embodiment of the invention, the contact points 18 are ferrous metal, such as chrome or polished steel and may themselves have a decorative shape or appearance so that when used without the decorative covers straps 16 or 20 the brow band 12 and cheek straps 14 present a finished, decorative appearance. In this embodiment, the decorative brow band cover strap 16 and cheek cover strap 20 have any desired decorative material on the exposed outer side, and small magnets 22 applied to the inner side in spaced-part positions to overlay and magnetically attach to the contact points 18, as shown. In this manner, numerous decorative cover straps can be made or purchased and easily replaced when desired to achieve a different decorative appearance when desired.

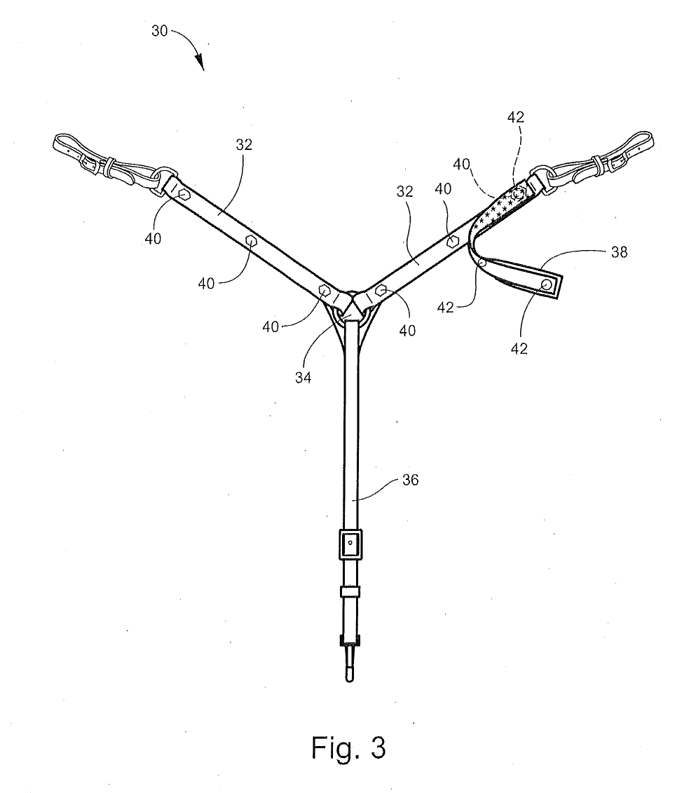

Referring to FIGS. 1 and 3, the breastplate 30 includes a pair of neck and withers straps 32, a yoke 34, and a breast strap 36 that extends between the horse's legs. These are attached to other tack such as the saddle or belly band in the normal matter. The neck and withers straps 32 are shown positioned beneath a decorative neck and withers cover strap 38 that is easily removable and replaceable when desired. A similar decorative neck and withers cover strap 38 would be placed over the other neck and withers strap 32 to form a decorative pair.

The neck and withers straps 32 each include spaced-apart contact points 40. In accordance with one preferred embodiment of the invention, the contact points 40 are ferrous metal, such as chrome or polished steel and are themselves decorative so that when used without the decorative covers straps they present a finished, decorative appearance. In this embodiment, the decorative cover strap 38 has any desired decorative material on the exposed outer side, indicated by crosshatching, and small magnets 42 applied to the inner side in spaced-part positions to overlay and magnetically attach to the contact points 40, as shown. In this manner, numerous decorative cover straps can be made or purchased and easily replaced when desired to achieve a different decorative appearance when desired.

Other attachment elements and devices are within the scope of the invention, including complementary hook and loop or other touch fastener material, cohesive tapes, double-sided tape and snap sets, or other suitable attaching devices and elements, selected and applied as appropriate between the functional straps and overlaid decorative straps.

Equestrian tack provided with features that permit quick and easy replacement of outer decorative elements is described above. arious details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A decorative cover for being removably applied to an outer surface of an equestrian tack component, comprising:
(a) a substrate having a size and shape corresponding to the surface of the tack to be covered;
(b) decorative elements applied to an outer-facing surface of the substrate; and
(c) an inner-facing surface adapted for being removably carried by the tack.

2. A decorative cover according to claim 1, and including attachment means carried by the inner-facing surface for cooperating with complementary attachment means carried by the outer surface of the tack component.

3. A decorative cover according to claim 1, wherein the attachment means are selected from the group consisting of magnets and ferrometallic elements, touch fasteners, cohesive tapes, double-sided tape and snap sets.

4. A decorative cover according to claim 3, wherein the decorative cover has a size and shape corresponding to the surface desired to be covered of a headstall cheek strap.

5. A decorative cover according to claim 3, wherein the decorative cover has a size and shape corresponding to the surface desired to be covered of a headstall brow band.

6. A decorative cover according to claim 3, wherein the decorative cover has a size and shape corresponding to the surface desired to be covered of a neck and withers strap of a breastplate.

7. A decorative cover according to claim 3, wherein the decorative cover has a size and shape corresponding to the surface desired to be covered of a breast strap of a breastplate.

8. A decorative cover for being removably applied to an outer surface of an equestrian tack component, comprising:
(a) a substrate having a size and shape corresponding to the surface of the tack to be covered;
(b) decorative elements applied to an outer-facing surface of the substrate;
(c) an inner-facing surface adapted for being removably carried by the tack; and
(d) attachment means carried by the inner-facing surface for cooperating with complementary attachment means carried by the outer surface of the tack components that are selected from the group consisting of magnets and ferrometallic elements, touch fasteners, cohesive tapes, double-sided tape and snap sets.

9. A decorative cover according to claim 8, wherein the decorative cover has a size and shape corresponding to the surface desired to be covered of a headstall cheek strap.

10. A decorative cover according to claim 8, wherein the decorative cover has a size and shape corresponding to the surface desired to be covered of a headstall brow band.

11. A decorative cover according to claim 8, wherein the decorative cover has a size and shape corresponding to the surface desired to be covered of a neck and withers strap of a breastplate.

12. A decorative cover according to claim 8, wherein the decorative cover has a size and shape corresponding to the surface desired to be covered of a breast strap of a breastplate.

13. A set of decorative covers for being removably applied to an outer surface of an equestrian tack components, comprising:
(a) a plurality of substrates having sizes and shapes corresponding to the surfaces of respective first and second headstall cheek straps, a headstall brow band, and first and second neck and withers strap of a breastplate;
(b) decorative elements applied to an outer-facing surface of the substrates; and
(c) an inner-facing surface of each substrate adapted for being removably carried by the tack.

14. A set of decorative covers according to claim 13, and including attachment means carried by the inner-facing surface for cooperating with complementary attachment means carried by the outer surface of the tack component.

15. A set of decorative covers according to claim 1, wherein the attachment means are selected from the group consisting of magnets and ferrometallic elements, touch fasteners, cohesive tapes, double-sided tape and snap sets.
